(19) United States
(12) Patent Application Publication
(10) Pub. No.: US 2007/0074276 A1
(43) Pub. Date: Mar. 29, 2007

(54) Method of operating a one-time pad system and a system for implementing this method

(76) Inventors: Keith Alexander Harrison, Bristol (GB); Christopher Tofts, Bristol (GB); Timothy Paul Spiller, Bristol (GB); Martin Sadler, Bristol (GB); William John Munro, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/490,478

(22) Filed: Jul. 19, 2006

(30) Foreign Application Priority Data
Sep. 29, 2005 (GB) 0519842.9
Oct. 28, 2005 (JP) 0512934.0

(51) Int. Cl. H04L 9/32

(52) U.S. Cl. 726/4

(57) ABSTRACT

A system is disclosed in which a plurality of devices are arranged to use one-time pad data to interact with apparatus holding the same one-time pad data. Each of the devices and the apparatus has its own one-time pad and the pads are all provisioned with the same new one-time pad data. Upon any one of the devices wishing to effect an interaction with the apparatus using one-time pad data, an alignment operation is carried out between a set of entities comprising at least the apparatus and the device wishing to carry out the interaction. The alignment operation serves to reduce the level of the one-time pad of at least the device wishing to carry out the interaction, to the level of the lowest one-time pad of the set of entities involved in the alignment operation.

### FIELD OF THE INVENTION

The present invention relates to a method of operating a one-time pad system and a system for implementing this method.

### BACKGROUND OF THE INVENTION

As is well known, two parties that possess the same secret random data can provably achieve both unbreakable secure communication using the Vernam cipher, and discrimination between legitimate messages and false or altered ones (using, for example, Wegman-Carter authentication). In both cases, however, data used from the secret random data shared by the parties must not be re-used. The term “one-time pad” is therefore frequently used to refer to the secret random data shared by the parties and this term, or its acronym “OTP”, is used herein for secret random data shared by more than one party. Although for absolute security the one-time pad data must be truly random, references to one-time pads (OTP) herein includes secret data that may not be truly random but is sufficiently random as to provide an acceptable degree of security for the purposes concerned.

The fact that the OTP data is effectively consumed when used gives rise to a major drawback of the employment of OTP cryptographic systems, namely that the OTP must be replenished.

One approach to sharing new OTP data between two parties is for one party to generate the new OTP data and then have a copy of the data physical transported in a storage medium to the other party. This is costly to do, particularly where it needs to be done frequently; furthermore, it may not be feasible to adopt this approach (for example, where one of the parties is a communications satellite).

Another approach is to send the OTP data over a communications link encrypted using a mathematically-based encryption scheme. However, this approach effectively reduces the security level to that of the encryption scheme used; since no such schemes are provable secure and may well prove susceptible to attack as a result of advances in quantum computing, this approach is no better than replacing the intended OTP system with a mathematically-based scheme.

More recently, quantum key distribution (QKD) methods and systems have been developed which enable two parties to share random data in a way that has a very high probability of detecting any eavesdroppers. This means that if no eavesdroppers are detected, the parties can have a high degree of confidence that the shared random data is secret. QKD methods and systems are described, for example, in U.S. Pat. No. 5,515,438 and U.S. Pat. No. 5,999,285. In known QKD systems, randomly polarized photons are sent from a transmitting apparatus to a receiving apparatus either through a fiber-optic cable or free space.

As a consequence of the actual and perceived problems of sharing secret random data, OTP cryptographic systems have generally only been used in applications where the security requirements are paramount such as certain military and government applications.

Because OTP cryptography is generally only employed where very high security is needed, the types of system where it is used are those where other components of the overall system do not significantly compromise the level of security provided by OTP cryptography. In particular, there is little point in using OTP cryptography for passing secret messages between parties if the messages are to be stored or subsequently transmitted in a manner that is significantly less secure. Furthermore, the storage of the OTP data itself represents a security threat and unless the OTP data can be stored in a highly secure manner, it is better to share OTP data only at a time immediately before it is to be consumed.

### SUMMARY OF THE INVENTION

It is an insight of the present inventors that OTP data can usefully be employed in systems with less than the highest levels of security and in such cases it is possible share OTP data more flexibly.

According to one aspect of the present invention, there is provided a method of operating a system in which a plurality of devices are arranged to use one-time pad data to interact with apparatus holding the same one-time pad data, the method comprising:
provisioning respective one-time pads of the devices and apparatus with the same new one-time pad data;
upon any said device, herein the pending-active device, wishing to effect an interaction with the apparatus using one-time pad data, carrying out an alignment operation between a set of entities comprising at least the pending-active device and the apparatus, to reduce the level of at least the one-time pad of the pending-active device to the level of the lowest one-time pad of said set of entities.

According to another aspect of the present invention, there is provided a system comprising:
apparatus with a one-time pad; and
a plurality of devices each with its own one-time pad that is the same as or a subset of the one-time pad held by the apparatus, each device being arranged to use one-time pad data from its one-time pad to interact with said apparatus;
wherein each device is so arranged that upon the device wishing to effect an interaction with the apparatus using one-time pad data, it participates in an alignment operation between a set of entities comprising at least itself and said apparatus, to reduce the level of at least its own one-time pad to the level of the lowest one-time pad of said set of entities.

### BRIEF DESCRIPTION OF THE DRAWINGS

Embodiments of the invention will now be described, by way of non-limiting example, with reference to the accompanying diagrammatic drawings, in which:

FIG. 1 is a diagram of a generalised form of user OTP device used in embodiments of the invention;

FIG. 2A is a diagram illustrating the use of a trusted data store to transfer OTP data;

FIG. 2B is a diagram illustrating the use of a first form of trusted random data generator to generate and distribute OTP data;

FIG. 2C is a diagram illustrating the use of a second form of trusted random data generator to generate and distribute OTP data;

FIG. 3 is a diagram depicting a user OTP device interacting with a distributed data processing system;

FIG. 4 is a diagram illustrating an embodiment of the invention in which multiple OTP devices are provisioned with the same OTP data and interact with complementary OTP apparatus also provisioned with the same OTP data; and

FIG. 5 is a diagram illustrating a global one-time pad alignment process effected between the OTP devices and apparatus of the FIG. 4 embodiment.

### BEST MODE OF CARRYING OUT THE INVENTION

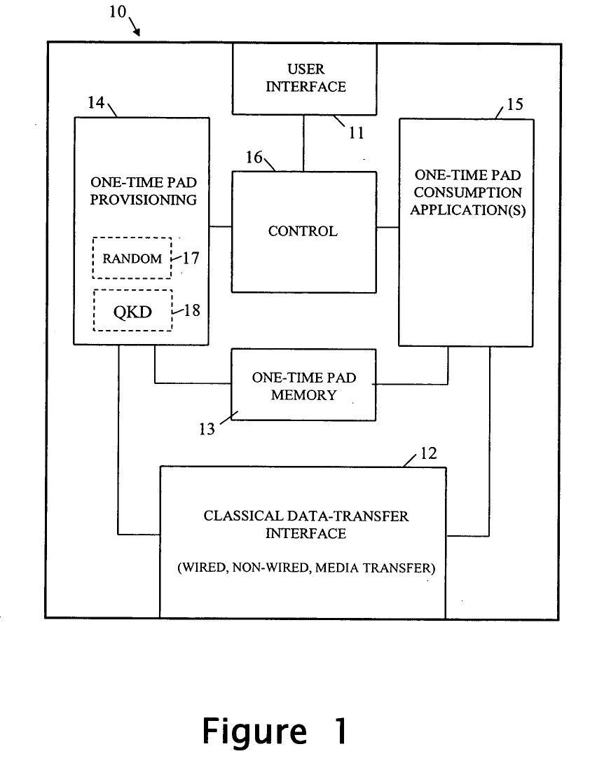

FIG. 1 shows, in generalized form, a user OTP device 10 for storing and using one-time pad data for various applications such as, for example, encryption and identification. Preferred embodiments of the device 10 are portable in form and are, for example, constituted by hand-held devices such as mobile phones and PDAs; however, other embodiments of the apparatus 10 can be of non-portable form such as a personal desktop computer.

In use, the OTP device 10 is intended to communicate with OTP apparatus having access to the same secret random data as the device 10 in order to conduct an OTP interaction (that is, an interaction requiring use of the same OTP data by the device and apparatus). Such OTP apparatus is hereinafter referred to as the “complementary OTP apparatus” with respect to the device 10; this apparatus can be of the same general form as the user OTP device 10 or can be of a different form and/or form part of a distributed system as will be described more fully hereinafter. Generally, the complementary OTP apparatus will be shown with a circular boundary in the Figures and will be referenced ‘20’.

The User OTP Device 10

The user OTP device 10 comprises the following functional blocks:
a user interface block 11 for interfacing with a user;
a classical data-transfer interface 12 for transferring data to and/or from external entities by wired or non-wired means, or by media transfer;
a memory 13 for storing OTP data;
an OTP provisioning block 14 which, through interaction with an external entity, is arranged to provide new secret random data for initializing or replenishing the memory 13 with OTP data;
an OTP consumption block 15 for carrying out one or more security-related applications that consume OTP data stored in memory 13; and
a control block 16 for controlling and coordinating the operation of the other blocks in response to inputs received through the user interface 11 and the data-transfer interface 12.

Typically, the functional blocks 11 to 16 are implemented using a program-controlled processor together with appropriate specialized sub-systems. Further details of each block are given below for the case where a processor-based system (including a main processor and associated memory) is used to carry out at least most of the data processing tasks of the device 10, such tasks including, in particular, the control and coordination tasks of control block 16 and the running of the security applications embodying the OTP consumption block 15.

User Interface 11

The user interface 11 typically comprises an LCD display and an input keypad but may also include audio input and/or output means.

Classical Data-Transfer Interface 12

The classical data-transfer interface 12 can comprise a non-wired interface such as a Bluetooth (Trademark) wireless interface or an IrDA infrared interface; however, a wired interface can alternatively or additionally be provided such as an USB interface (as used herein, the term “wired” is to be understood broadly to cover any type of interface that requires electrical elements to be brought into physical contact). For circumstances where transit delay is not an issue, it is also possible to implement the data-transfer interface 12 as a removable storage medium and related read/write arrangement.

OTP Memory 13

The OTP memory 13 can be part of the general memory associated with the main processor of device 10 or can be formed by a separate memory. In either case, the OTP data is preferably secured against unauthorized access by one or more appropriate technologies. For example, the memory 13 can all be provided in a tamper-resistant hardware package. Alternatively, a protected storage mechanism can be used in which all but the root of a hierarchy (tree) of encrypted data objects is stored in ordinary memory, the root of the hierarchy being a storage root key which is stored in a tamper-resistant hardware package and is needed to decrypt any of the other data objects of the hierarchy. Furthermore, trusted platform techniques can be used to ensure that only authorized software can access the OTP data. It is also possible to use QRAM (Quantum RAM) technologies.

Where the device 10 is designed such that OTP data is consumed immediately following its provisioning, the security requirements of memory 13 can be reduced (unless the device 10 is designed to operate unattended).

OTP Provisioning Block 14

With regard to the OTP provisioning block 14, the most secure way to share secret random data is to use a quantum key distribution method such as described in the documents referenced in the introduction to the present specification. In this case, the OTP provisioning block is provided with a QKD subsystem 17 that can be either a QKD transmitter or a QKD receiver. It is relatively straightforward to incorporate a QKD transmitter within a hand-held device and then to provide a cradle or similar mechanical arrangement to ensure that the device is properly optically aligned to interact with a fixed QKD receiver subsystem. In fact, it is possible to dispense with a mechanical alignment arrangement by the use of an automated or semi-automated alignment system such as is disclosed in our co-pending U.S. patent application Ser. No. 11/454,624, filed 16 Jun. 2006.

The OTP provisioning block 14 need not be built around a QKD subsystem and a number of alternative embodiments are possible. Thus, in one such alternative embodiment the OTP provisioning block 14 is simply be arranged to store to the OTP memory 13, secret random data received via the data-transfer interface 12 from either:
(i) OTP apparatus seeking to share secret random data with the device 10 either directly or via a trusted data store;
(ii) a trusted random data generator that has the role of generating secret random data and passing it both to the user device 10 and to OTP apparatus with which the device 10 is wishing to interact using shared OTP data

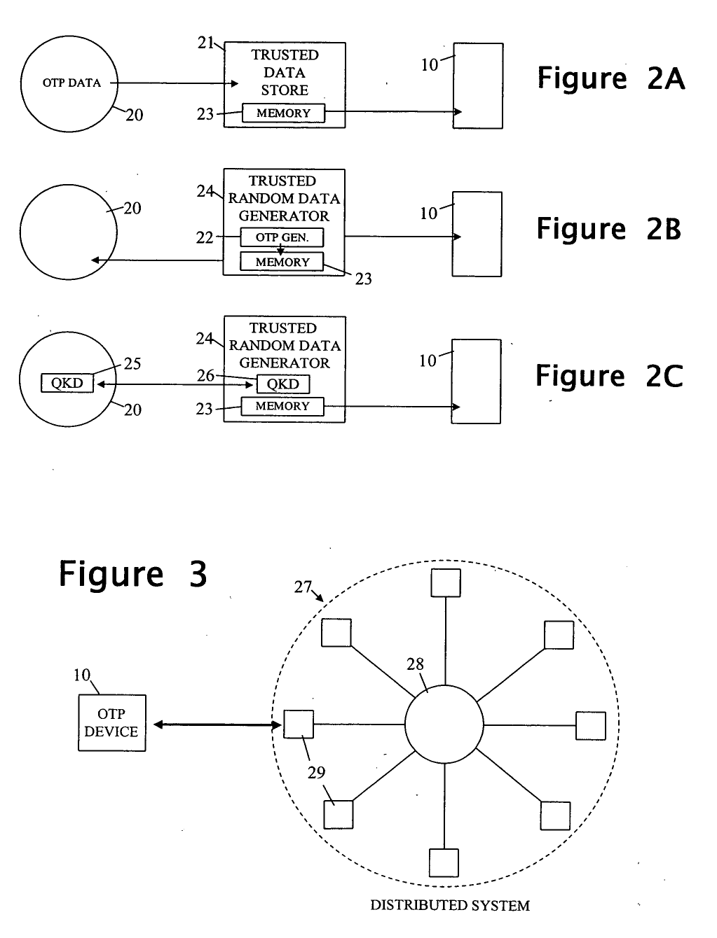

FIG. 2A illustrates the use of a trusted data store 21 for transferring secret random data to the device 10. In FIG. 2A, secret random data provided by the complementary OTP apparatus 20 is first passed to the trusted data store where it is held in memory 23 before being subsequently transferred to the OTP device 10. The trusted data store 21 can be infrastructure equipment or stand-alone equipment such as a hand-held device.

FIG. 2B illustrates the use of a trusted random data generator 24. The trusted generator 24 includes a random data generation arrangement 22 for generating the random data, this data being generated at a time that the trusted random data generator 24 is in communication with the device 10 so that the random data can be passed immediately to the device 10. The trusted random data generator 24 also stores the random data it has generated in memory 23 and subsequently transfers this data to the complementary OTP apparatus 20. It will be appreciated that the random data could have been generated when the generator 24 was in communication with the apparatus 20 and then subsequently passed by the generator 24 to the device 10. It would also be possible for the generator 24 to only generate random data when in communication both the device 10 and apparatus 20 so that the random data is passed to both immediately, obviating the need for the memory 23. Conversely, the random data could be generated in advance of the trusted random data generator 24 being in communication with either of the device 10 and apparatus 20 in which case the random data is stored in memory 23 and subsequently passed to each of the device 10 and apparatus.

In the FIG. 2B form of the trusted random data generator 24, the random data is generated by the generator 24 acting alone. FIG. 2C shows a different form of the trusted random data generator 24 in which a QKD arrangement is used to generate the OTP data—in the illustrated scenario, the trusted random data generator 24 includes a QKD transmitter 26 arranged to interact with a QKD receiver 25 in the apparatus 20 in order to generate secret random data. The QKD transmitter 26 and receiver 25 can, of course, be swapped around; furthermore, the OTP data could alternatively be generated by a QKD interaction between the trusted generator 24 and a QKD entity in the device 10. As with the FIG. 2B trusted random data generator 24, the generator 24 of FIG. 2C also includes a memory 23 for storing the generated random data prior to transfer to the device 10 (or to the apparatus 20 if the QKD interaction was with the device 10).

The trusted random data generator 24 can be totally independent of the OTP device 10 and OTP apparatus 20 or can be associated with one of these entities—for example, the trusted random data generator 24 can be run by a bank that also runs the OTP apparatus 20.

Returning now to a consideration of the provisioning block 14 of the device 10, rather than the secret random data being generated using a QKD subsystem or being received by the provisioning block 14 from an external source, the OTP provisioning block 14 can include a random data generator 17 for generating random data which is both used to provision the memory 13 with OTP data, and passed via the data-transfer interface 12 directly or indirectly (including via a trusted data store) to other OTP apparatus with which the device 10 wishes to conduct OTP interactions. The random data generator is, for example, a quantum-based arrangement in which a half-silvered mirror is used to pass/deflect photons to detectors to correspondingly generate a “0”/“1” with a 50:50 chance; an alternative embodiment can be constructed based around overdriving a resistor or diode to take advantage of the electron noise to trigger a random event. Other techniques can be used for generating random data, particularly where a reduced level of security is acceptable—in such cases, some relaxation can be permitted on the randomness of the data allowing the use of pseudo random binary sequence generators which are well known in the art.

Where the secret random data is being received or being passed on via the classical data-transfer interface 12, it is highly desirable for the data to be encrypted (except possibly where a wired interface is being used to interface directly with OTP apparatus or a trusted data store). The encryption should not, of course, be based on the Vernam cipher using existing OTP data from the memory 13 since in this case as least as much OTP data would be consumed as newly provisioned; however the existing OTP data can be used to form a session key for the (relatively) secure transfer of the new secret random data.

It will be appreciated that the level of security that applies to the sharing of secret random data between the device 10 and other OTP apparatus sets the maximum level of security that can be achieved using a one-time pad formed from this data; accordingly, if the user of the device 10 wishes to use the OTP data held in the device 10 to achieve very high levels of security for data transfer from the device, then the initial sharing of the secret random data must involve corresponding levels of security; however, if the OTP data is only to be used for applications that do not warrant the highest levels of security, then the security surrounding secret random data sharing can be relaxed.

It will also be appreciated that the sharing of the secret random data used for the one-time pads is generally restricted to entities that know something about each other (such as their respective identities or some other attribute); accordingly, the sharing of the secret random data will normally be preceded by a verification or qualification process during which each entity satisfies itself that the other entity possesses appropriate attributes. This applies not only for the OTP device 10 and the complementary OTP apparatus 20, but also to the trusted data store 21 and the trusted random data generator 24 which should check the attributes of any entity purporting to entitled to receive OTP data before such data is passed on to that entity.

The provisioning block 14 can simply append newly-obtained secret random data to the existing OTP data in memory 13 or can combine the new secret random data with the existing OTP data using a merge function, the merged data then replacing the previous contents of the memory 13. Preferably, the merge function is such that an eavesdropper who has somehow managed to obtain knowledge of the new secret random data, cannot derive any part of the merged data without also having knowledge of the pre-existing OTP data in the memory 13. A wide range of possible merge functions exist including functions for encrypting the new secret random data using the existing OTP data for the encrypting key, and random permutation functions (it will be appreciated that whatever merge function is used, it must be possible for the complementary OTP apparatus to select and use the same function on its copy of the new secret random data and its existing OTP data). Merging of the new secret random data and existing OTP data otherwise than by aggregation, can only be done if the device 10 and the complementary OTP apparatus have the same existing OTP data which should therefore be confirmed between the device and apparatus before the new secret random data and existing OTP data are subject to merging. In this respect, it will be appreciated that the OTP device 10 and the complementary OTP apparatus may not have the same existing OTP data for a variety of reasons such as a failed communication between the device and apparatus resulting in one of them consuming OTP data but not the other. Of course, it will frequently be possible for the OTP device and the complementary OTP apparatus to cooperate such that if either of them still has OTP data already discarded by the other, then that entity also discards the same data (one method of doing this is described later). However, it will not always be possible for the device 10 and the complementary OTP apparatus to cooperate in this way, or even check whether they have the same existing OTP data, at the time that one or other of the device and apparatus is provided with new secret random data—for example, if the OTP device is being replenished with new secret random data by communication with a trusted random data generator, it may well be that the trusted random data generator is not concurrently in communication with the OTP apparatus, the new secret random data only being subsequently shared with the OTP apparatus. In this type of situation, the new secret random data must be appended to the existing OTP data rather than being merged with it.

OTP Consumption Block 15

The OTP consumption block 15 is arranged to carry out tasks (‘applications’) that require the use (‘consumption’) of OTP data from the memory 13; it is to be understood that, unless otherwise stated herein, whenever data is used from the OTP data held in memory 13, that data is discarded. As already indicated, the OTP consumption block 15 is preferably provided by arranging for the main processor of the device 10 to execute OTP application programs; however, the consumption block 15 can additionally/alternatively comprise specialized hardware processing elements particularly where the OTP application to be executed involves complex processing or calls for high throughput.

A typical OTP consumption application is the generation of a session key for the exchange of encrypted messages with the complementary OTP apparatus; in this case, the complementary OTP apparatus can generate the same session key itself. Of course, the device 10 can securely communicate with the complementary OTP apparatus by encrypting data to be sent using the Vernam cipher—however, this would require the use of as much OTP data as there was data to be exchanged and so give rise to rapid consumption of the OTP data from memory 13.

Another OTP consumption application is the evidencing that the device 10 (or its owner/user) possesses a particular attribute. As already noted, the distribution of the secret random data used for the one-time pads is generally restricted to entities that know something about each other, such as their respective identities or the possession of other particular attributes (in the present specification, reference to attributes possessed by an entity includes attributes of a user/owner of the entity). An example non-identity attribute is an access authorisation attribute obtained following a qualification process that may involve the making of a payment. The secret random data will only be shared after each entity (or a trusted intermediary) has carried out some verification/qualification process in respect of the identity or other attributes of the other entity concerned. This verification/qualification can simply be by context (a bank customer replenishing their device 10 from an OTP apparatus within a bank may be willing to accept that the secret random data being received is shared only with the bank); however, verification/qualification can involve checking of documentary evidence (for example, a paper passport), or an automatic process such as one based on public/private keys and a public key infrastructure. Whatever verification/qualification process is used to control the sharing of secret random data, once such sharing has taken place, OTP data based on the secret random data can be used to prove the identity or other attributes of the possessor of the OTP data. Thus, for example, if OTP apparatus knows that it shares OTP data with an OTP device 10 with identity “X”, then the device 10 can identify itself to the complementary OTP apparatus by sending it a data block from the top of its one-time pad; the apparatus then searches for this data block in the one or more OTP pads it possesses and if a match is found, it knows that it is communicating with entity “X”. To aid finding a match, the device 10 preferably sends the OTP apparatus an identifier of the one-time pad that the device is proposing to use.

As already noted, communication failures and other issues can result in different amounts of OTP data being held by the OTP device 10 and the complementary OTP apparatus; more particularly, the data at the top of the one-time pad held by device 10 can differ from the data at the top of the one-time pad held by the complementary OTP apparatus. This is referred to herein as “misalignment” of the one-time pads. It is therefore convenient for the OTP device and the complementary OTP apparatus to each obtain or maintain a measure indicating how far it has progressed through its OTP data; this measure can also be thought of as a pointer or index to the head of the OTP pad and is therefore referred to below as the “head index”. Preferably, the head index is taken as the remaining size of the OTP data; although other measurements can be used for the head index (such as how much OTP data has been used), measuring the remaining size of the OTP data can be done at any time and so does not require any on-going maintenance. Whatever actual numeric value of the measure used for the head index, in the present specification the convention is used, when discussing head index values, that the nearer the top of the one-time pad is to the bottom of the pad, the “lower” is the value of the head index.

The head index is used to correct for misalignment of the one time pads held by the device 10A and the complementary OTP apparatus as follows. At the start of any OTP interaction, the device 10 and complementary OTP apparatus exchange their head indexes and one of them then discards data from the top of its one-time pad until its head index matches that received from the other—that is, until the one-time pads are back in alignment at the lowest of the exchanged head index values. When OTP data is used by the device or apparatus in conducting the OTP transaction, the head index is sent along with the OTP interaction data (e.g. an OTP encrypted message) to enable the recipient to go directly to the correct OTP data in its one-time pad; this step can be omitted since although the one-time pads may have become misaligned by the time a message with OTP interaction data successfully passes in one direction or the other between the device and apparatus, this misalignment is likely to be small and a trial-and-error process can be used to find the correct OTP data at the receiving end.

The Complementary OTP Apparatus

With regard to the complementary OTP apparatus with which the OTP device 10 shares the same OTP data and can therefore conduct an OTP-based interaction, this can be constituted by apparatus in which all three functions of OTP storage, provisioning, and consumption are contained within the same item of equipment (as with the device 10); such OTP apparatus is referred to herein as “self-contained” OTP apparatus. However, it is also possible for the complementary OTP apparatus to be distributed in form with one of the OTP storage, provisioning, and consumption functions being in a separate item of equipment from the other two, or with all three functions in separate items of equipment to the OTP storage and provisioning functions; such OTP apparatus is referred to herein as “distributed” OTP apparatus. In distributed OTP apparatus it is, of course, necessary to ensure an adequate level of security for passing OTP data between its distributed functions. It is conceivable that one or both of the provisioning and consumption functions are provided by equipment that is also used by another distributed OTP apparatus.

To illustrate the different roles that self-contained and distributed OTP apparatus can play, FIG. 3 shows the OTP device 10 conducting an OTP interaction with a distributed data processing system 27 such as a banking system. The distributed system 27 comprises a central computer facility 28 that communicates with a plurality of customer-interfacing units 29 by any suitable communications network. The device 10 can communicate with one or more of the units 29 using its classical data-transfer interface 12.

In one possible scenario, each of the units 29 is a self-contained OTP apparatus holding OTP data that is distinct from the OTP data held by any other unit 29; in this case, assuming that the device 10 only holds one pad of OTP data, it is restricted to interacting with the unit 29 that holds the same pad. Alternatively, the OTP device 10 can be arranged to hold multiple pads of OTP data each corresponding to a pad held by a respective one of the units 29, the device 10 then needing to use data from the correct pad for the unit 29 with which it wishes to conduct an OTP interaction.

In an alternative scenario, the central computer facility 28 is a self-contained OTP apparatus, the device 10 conducting the OTP interaction with the facility 28; in this case, each of the units 29 is simply a communications relay for passing on the OTP interaction messages.

In a further alternative scenario, the central computer facility 28 holds the OTP data shared with the device 10 but the units 29 are consumers of that data; in this case, the device 10 conducts the OTP interaction with one of the units, the unit obtaining the needed OTP data from the facility 28 over the internal network of the distributed system. In this scenario, the distributed system 27 forms a distributed OTP apparatus.

It may be noted that in the last scenario, it is possible to arrange for each of the units 29 to be capable of taking part in an OTP provisioning operation with the device 10, either by passing on to the central computer facility 28 secret random data provided by the device 10, or by generating random data and passing it both to the device 10 and to the central facility 28; in this latter case, the units 29 independently generate their random data.

Whatever the form of the complementary OTP apparatus, it may have been designed to carry out OTP interactions with multiple different devices 10, each with its own OTP data. This requires that the complementary OTP apparatus hold multiple different pads of OTP data, one for each device 10 with which it is to conduct OTP interactions; it also requires that the OTP apparatus uses the correct OTP data when interacting with a particular OTP device 10. One way of enabling the OTP apparatus to determine quickly which is the correct pad of OTP data to use in respect of a particular device 10, is for each pad to have a unique identifier which the device sends to the apparatus when an OTP interaction is to be conducted. It is not necessary for this identifier to be sent securely by the device 10 (unless there are concerns about an eavesdropper tracking patterns of contact between particular devices and the apparatus).

Multiple Devices with the Same OTP Data

Where multiple OTP devices are arranged to interact with the same complementary OTP apparatus, then rather than each device having its own unique OTP data, it is possible to arrange for each device to use the same OTP data as the other devices. This, of course, implies a high level of trust between the devices since the security properties inherent in the use of one-time pads depend on the pad data being held securely by all entities authorized to possess the data. It also means that any one device can repudiate any transaction based on its OTP data since any other one of the devices could equally have effected the transaction. As a result, providing each of multiple devices with the same OTP data is most suitable for use in situations where there is group responsibility. A typical usage scenario is that of devices possessed by members of a single team, or of a single family, all wishing to communicate securely with, or use a service of, a central resource (apparatus 20).

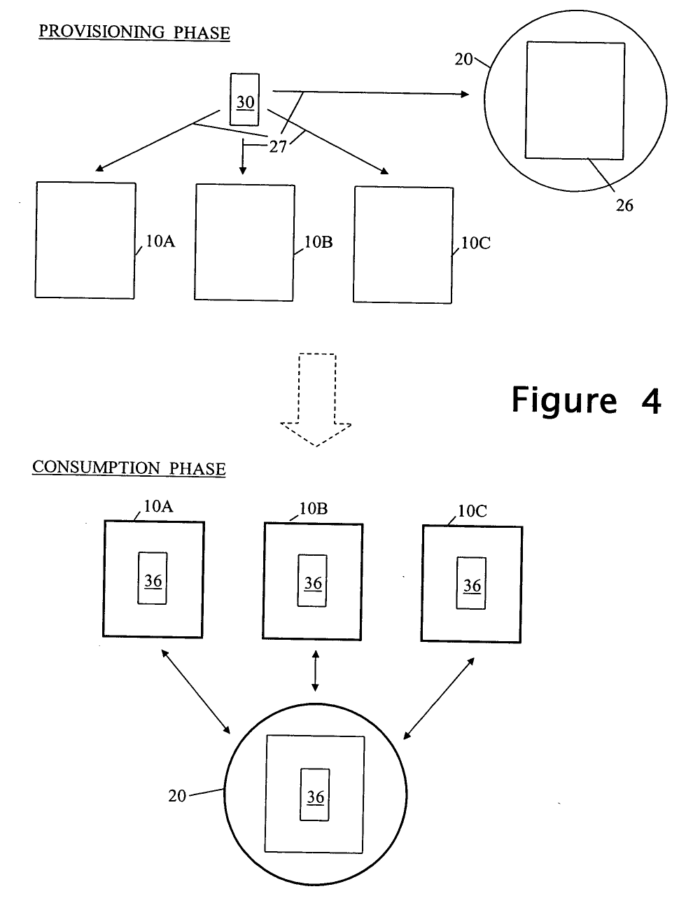

FIG. 4 depicts a situation in which multiple OTP devices 10A, 10B and 10C are provisioned (arrows 27) with the same secret random data 36; a complementary OTP apparatus 20 (of self-contained or distributed form) is also provisioned with the same secret random data 36. In this example, the devices 10A, 10B, 10C and apparatus 20 directly use the secret random data 36 as one-time pad data, typically appending it to any existing OTP data already held (the devices hold their OTP data in their memories 13 and the apparatus holds its OTP data in memory 26).

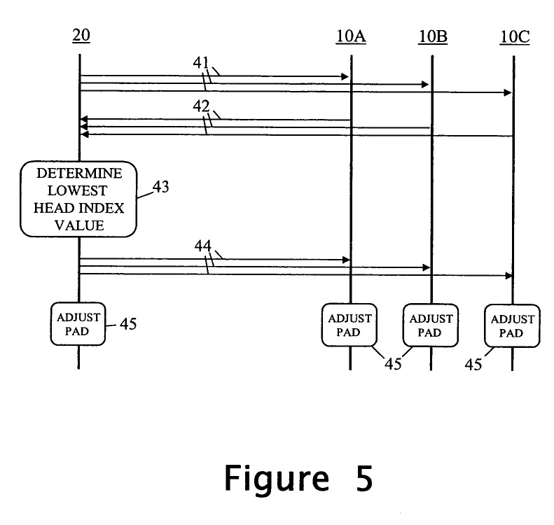

Once the devices 10A, 10B, 10C and the apparatus 20 have been provisioned with one-time data, the devices 10A, 10B and 10C separately conduct OTP interactions with the apparatus 20 (see lower half of FIG. 5).

Pad Alignment for OTP Consumption

Whenever one of the devices 10A, 10B, 10C is about to interact with the apparatus 20 using its OTP data, the device and apparatus use the above-described head-index-based pad alignment mechanism to substantially align the OTP data they hold. In this way, any one-time pad data that has already been used by another device to interact with the apparatus 20, is discarded.

It should, however, be noted that it is possible for OTP data to be have been used by one of the devices 10A, 10B, 10C in an abortive OTP interaction observed by an eavesdropper but without either the apparatus or any of the other devices being aware that this has happened. As a result, even after a device 10A, 10B, 10C has effected a pad alignment operation with the apparatus 20, the possibility remains that the one-time pads of the device and apparatus still hold one-time pad data that has already been abortively consumed by another device (unless, of course, the latter device has, since its abortive OTP consumption operation, carried out a pad alignment operation with the OTP apparatus).

If this situation is allowed to exist, then it is possible for the same OTP data to be used twice implying that above-described sharing of OTP data by multiple devices should not be employed where a high level of security is needed (which, in any event, is unlikely because sharing the same OTP data between multiple devices would not be done for the highest security applications).

Alternatively, measures can be taken to eliminate the risk of there being already-used OTP data present in the one-time pads of the apparatus 20 and an interacting device after pad alignment. One way of doing this is to arrange for a global pad alignment to be effected whenever an OTP device wishes to interact with the apparatus 20; by “global alignment” is meant the aligning of the one-time pads of the apparatus and all the devices at the level of the most-consumed one-time pad. A global alignment can be achieved by the method illustrated in FIG. 5 in which:
the apparatus 20 request all the devices 10A, 10B, 10C to transmit their head indexes to the apparatus (see arrows 41);
the devices 10A, 10B, 10C reply with their current head index values (see arrows 42);
the apparatus 20 determines (operation 43) from these head index values and its own head index value, which head index is the lowest (that is, indicative of the most consumed pad);
the apparatus 20 sends this head-index value to all devices 10A, 10B, 10C (see arrows 44);
the apparatus 20 and the devices 10A, 10B, 10C all align their one-time pads to this head index value (operations 44).

Once a global alignment has been effected, the device wishing to carry out an OTP interaction with the apparatus 20 can proceed to do so. It will be appreciated that a check should be made that all devices have participated in the global alignment for which purpose the apparatus can be arranged to keep a record of all the devices and the devices can be required to authenticate themselves to the apparatus when sending their had index values (the latter being integrity protected). It will also be appreciated that a fresh global alignment is required for each OTP interaction between a device and the apparatus and that a device should not consume OTP data except when it conducting an OTP interaction with the apparatus that the apparatus is expecting—that is, one for which a global alignment has been effected.

Alternative protocols can be used to effect global alignment; for example, the apparatus—or one of the devices—can be arranged to trigger a broadcast by all the devices and the apparatus of their respective head indexes so each device and the apparatus can independently determine at what pad level to effect alignment.

In another alternative global alignment protocol, the devices and apparatus inter-communicate in the manner of a unidirectional ring with each entity (device/apparatus) passing on the lowest of its own head index value and a head index value just received from the upstream ring entity (one entity would have the role of initiating this process by sending its current head index value). Two circuits of the ring should result in a stable lowest head-index value that has been propagated to all entities. Each entity can be arranged such that as soon as it receives back the same value of head index as it last passed on, the entity aligns its one-time pad to that value; the entity would still pass on the value but the next time it received the value it would not pass it on again.

Of course, effecting global alignment is a significant overhead and requires that all the OTP devices and the complementary OTP apparatus participate. Accordingly, it can be decided to adopt a hybrid manner of operation in which a global alignment of the one-time pads is only effected where a very high level of security is required for an OTP interaction; for other OTP interactions, either only a best-efforts global alignment is effected (that is, a global alignment but limited to currently-available devices), or alignment is limited simply to a “local” pad alignment between the apparatus and the device wishing to interact with the apparatus. More generally expressed, the number of OTP devices required to be involved in the alignment process is dependent on the security level associated with the intended OTP interaction, more devices being required when the intended interaction has a higher security level.

In the foregoing discussion of multiple OTP devices sharing the same OTP data, it has been assumed that each device is arranged only to carry out OTP interactions with the apparatus 20. However, since the devices hold the same OTP data, the devices can also carry out OTP interactions with each other. Of course, this increases the risk of one-time pad data being used more than once (this time by different interacting pairings of the OTP entities constituted by the OTP devices and the OTP apparatus) unless a global alignment is effected for each OTP interaction with the non-participating OTP entities being locked against initiating another OTP interaction until after the current OTP interaction has been completed. To minimize global alignments, device-to-device OTP interactions can be banned altogether or restricted to use for lower security applications where the risk of multiple use of one-time pad data (when considered across all the devices sharing the same OTP data) is acceptable so that effecting a global alignment is not required.

Distributing the Secret Random Data

With regard to how the secret random data 36 is shared to all the devices 10A, 10B, 10C, and to the OTP apparatus 20, a single entity can be arranged to distribute the same secret random data individually to each of the devices 10A, 10B, 10C and the apparatus 20 using any of the methods described above when discussing the OTP provisioning block 14; the entity responsible for this distribution can the apparatus 20, one of the devices 10A, 10B, 10C, a trusted data store, or an OTP data generator. The secret random data is, for example, generated by the entity responsible for this distribution, either alone or by means of a QKD interaction with one of the devices 10A, 10B, 10C or the apparatus 20.

Rather than having a single entity responsible for sharing secret random data with every entity intended to receive it, an hierarchical distribution arrangement can be employed in which, for example, the apparatus 20 first shares the new secret random data 36 with the device 10A and the device 10A then copies all the new secret random data 36 to devices 10B and 10C, keeping a copy for itself. Thus, in a typical scenario, the OTP device 10A belongs to a person who is a parent in a family, the OTP devices 10B and 10C belong to other family members, and the OTP apparatus 20 is a bank; in this case, the user of device 10A periodically visits the bank 20 to effect a provisioning interaction (either via the classical data-transfer channel of the device or by using a QKD channel) after which device 10A transfers the new secret random data to the devices 10B, 10C via the classical data-transfer interface 12 (typically embodied for this purpose as a wired connection or IrDA link). It will be appreciated that a deeper hierarchical distribution pattern can, of course, be used where there are more devices to be provisioned.

However the new secret random data 36 is distributed to the devices 10A, 10B, 10C, appropriate measures can be taken, if desired, to ensure that none of the new secret random data is consumed until all devices have the data (for example, a start date for usage can be associated with the data, this date being chosen to be after when it is expected all of the devices will have received the new secret random data). However, it is not necessary to ensure that all devices have the new secret random data before consumption starts as the pad alignment mechanism can be used to take account of such consumption. Where the apparatus 20 is responsible for sharing the new secret random data 35 with each device, should one of the devices consume any of the new secret random data by interaction with the apparatus 20 before the apparatus has been able to distribute the secret random data to all the devices, the apparatus can be arranged to distribute only the unused secret random data to the subsequently-provisioned devices.

Merging New Secret Random Data with Existing OPT Data

In the foregoing discussion of the sharing of the same secret random data by multiple OTP devices and the complementary OTP apparatus, the secret random data has been used directly as OTP data. It is also possible for each device and the apparatus to merge new secret random it receives with existing OTP data it already holds in a manner already described above. Of course, for all OTP devices and the OTP apparatus to end up with the same OTP data after this merging, not only must they all be supplied with the same new secret random data, but their existing one-time pads must be aligned. This can be achieved by effecting a global alignment operation and requiring that the devices and apparatus then merge the new secret random data with their OTP data before any further OTP data is consumed. The global alignment operation can be effected before or after the secret random data is provided to the OTP devices and complementary OTP apparatus unless this provision of the secret random data involves use of any OTP data already held by the devices and apparatus in which case the global alignment operation must be effected after provision of the secret random data to the devices and apparatus.

A hybrid provisioning method can alternatively be used in which:
(a) a lead OTP device communicates with the other OTP devices to determine the lowest-valued head index of all the devices;
(b) the lead device aligns its one-time pad to the lowest-valued device head index it has just determined;
(c) the lead device effects a pad alignment operation with the OTP apparatus and the lead device and OTP apparatus share new secret random data (for example using a QKD method);
(d) the lead device and OTP apparatus independently merge the new secret random data with the OTP data they hold;
(e) the lead device shares its new OTP data with other devices (for example, either individually or by an hierarchical distribution arrangement).

The non-lead OTP devices either discard their old OTP data at some stage prior to step (e) or replace it with the new OTP data in step (e). In step (c) the sharing of the new secret random data can be effected before the pad alignment operation and, indeed, this must be the case if the sharing consumes one-time pad data. In a variant of this hybrid provisioning method, the lead device passes the lowest valued head index determined in (a) to the OTP apparatus which accordingly adjusts its one-time pad (unless its already has a lower head index value); the OTP apparatus then generates new secret random data and merges it with its existing one-time pad data before passing the new OTP data to the lead device for distribution to the other devices.

Variants

Many variants are possible to the above described embodiments of the invention. For example, although in the foregoing, embodiments of the invention have been described in relation to OTP devices that incorporate, in a self-contained form, OTP storage, provisioning, and consumption, it is to be understood that the devices could generally be replaced by a distributed arrangement of their functional blocks.

With regard to the pad alignment process carried out immediately preceding an OTP interaction between an OTP device and the complementary OTP apparatus, it may be noted that generally the level of the one-time pad of the apparatus will be lower than that of the device wishing to interact with it. The alignment process could therefore be limited to reducing the level of the one-time pad of the device wishing to effect an OTP interaction with the apparatus to the level of the lowest one of the entities (OTP devices, OTP apparatus) participating in the alignment process (whether the alignment being effected is a global or local pad alignment). Should the top of the one-time pad of the device wishing to effect an OTP interaction with the apparatus be lower than that of the apparatus (either as a result of the alignment process or otherwise), the discrepancy is likely to be small so that the apparatus could ascertain the correct OTP data to use in the OTP interaction by a search or trial and error process starting at the top of its OTP data (the apparatus would, of course, discard all OTP data above the level of the OTP data being used in the OTP interaction—in effect, alignment of the one-time pad of the apparatus has been deferred to the OTP consumption phase of the interaction between the device and apparatus).

In order to reduce the need to effect re-provisioning of the OTP devices and OTP apparatus with secret random data, it is possible to arrange for devices to consume their one-time pad data more than once where the security requirements permit such a reduction in the level of security. Such “n-time” use of the OTP data does not change the character of the secret random data subject to distribution or of the resulting OTP data and the accompanying claims are to be understood accordingly.

1. A method of operating a system in which a plurality of devices are arranged to use one-time pad data to interact with apparatus holding the same one-time pad data, the method comprising:
provisioning respective one-time pads of the devices and apparatus with the same new one-time pad data;
upon any said device, herein the pending-active device, wishing to effect an interaction with the apparatus using one-time pad data, carrying out an alignment operation between a set of entities comprising at least the pending-active device and the apparatus, to reduce the level of at least the one-time pad of the pending-active device to the level of the lowest one-time pad of said set of entities.

2. A method according to claim 1, wherein the alignment operation reduces the levels of the one-time pads of all the entities of said set to the level of the lowest of these pads.

3. A method according to claim 1, wherein the set of entities comprises said plurality of devices and the apparatus.

4. A method according to claim 1, wherein the set of entities comprises the apparatus and those devices that are currently contactable to participate in the alignment operation.

5. A method according to claim 2, wherein the set of entities comprises the apparatus and multiple said devices, the alignment operation comprising:
the apparatus communicating with said multiple devices to ascertain the levels of the one-time pads of these devices;
the apparatus determining the level of the lowest one of the one-time pads of said set of entities;
the apparatus communicating to said multiple devices the level of the lowest one of the one-time pads of said set of entities; and
the apparatus and said multiple devices each reducing the level of its own one-time pad to the level of the lowest one of the one-time pads of said set of entities.

6. A method according to claim 1, wherein the constitution of said set of entities is dependent on a security level associated with the intended interaction with the apparatus, the set being required to include more said devices when the intended interaction has a higher security level.

7. A method according to claim 1, wherein the devices are also arranged to effect interactions with each other using their one-time pad data, each such interaction being preceded by the carrying out of an alignment operation between a further set of entities comprising at least the devices that are to participate in the interaction, to reduce the levels of the one-time pads of the entities of said further set to the level of the lowest one of these pads.

8. A method according to claim 7, wherein said further set of entities comprises said plurality of devices and the apparatus.

9. A method according to claim 1, wherein the provisioning of the one-time pads of the devices and apparatus with the same new one-time pad data is effected by:
provisioning a first said device and the apparatus with the same secret random data;
distributing said secret random data from the first device to one or more other said devices in a hierarchical distribution pattern headed by the first device; and
each device and the apparatus using the secret random data to provide said new one-time pad data for its one-time pad.

10. A method according to claim 1, wherein the provisioning of the one-time pads of the devices and apparatus with the same new one-time pad data is effected by:
provisioning each device and the apparatus with the same secret random data; and
each device and the apparatus using the secret random data as one-time pad data for its one-time pad.

11. A method according to claim 1, wherein the devices and apparatus have pre-existing one-time pads based on the same pre-existing one-time pad data, the provisioning of the one-time pads of the devices and apparatus with the same new one-time pad data is effected by:
(a) carrying out an alignment operation to reduce the levels of the one-time pads of the said plurality of devices and apparatus to the level of the lowest one of these pads;
(b) provisioning each device and the apparatus with the same secret random data; and
(c) the devices and apparatus each using the secret random data to provide said new one-time pad data by merging, according to a predetermined merge function, the secret random data with the existing one-time pad of that device or apparatus, the merge function being such that a party with knowledge of the secret random data, cannot derive any part of the merged data without also having knowledge of the existing one-time pad;
(a) and (b) being effected in any order unless (b) involves use of any said pre-existing one-time pad data in which case (a) is effected after (b).

12. A method according to claim 1, wherein the devices and apparatus have pre-existing one-time pads based on the same pre-existing one-time pad data, the provisioning of the one-time pads of the devices and apparatus with the same new one-time pad data being effected by:
(a) carrying out an alignment operation to reduce the level of the one-time pad of a first one of the devices to the level of the lowest one-time pad of said plurality of devices;
(b) carrying out an alignment operation to reduce the level of the one-time pads of the first device and apparatus to the level of the lowest one of these pads;
(c) provisioning the first device and the apparatus with the same secret random data;
(d) the first device and apparatus each using the secret random data to provide new one-time pad data by merging, according to a predetermined merge function, the secret random data with its existing one-time pad, the merge function being such that a party with knowledge of the secret random data, cannot derive any part of the merged data without also having knowledge of the existing one-time-pad; and
(e) the first device sharing its new one-time pad data with the other devices;
(b) and (c) being effected in any order unless (c) involves use of the existing one-time pads in which case (b) is effected after (c).

13. A system comprising:
apparatus with a one-time pad; and
a plurality of devices each with its own one-time pad that is the same as or a subset of the one-time pad held by the apparatus, each device being arranged to use one-time pad data from its one-time pad to interact with said apparatus;
wherein each device is so arranged that upon the device wishing to effect an interaction with the apparatus using one-time pad data, it participates in an alignment operation between a set of entities comprising at least itself and said apparatus, to reduce the level of at least its own one-time pad to the level of the lowest one-time pad of said set of entities.
